(19) United States
(12) Patent Application Publication
(10) Pub. No.: US 2012/0314963 A1
(43) Pub. Date: Dec. 13, 2012

(54) Use of Master Resolution Image to Establish Authorship, and Applications Thereof

(75) Inventor: Arthur Blume, Melrose, MA (US)

(73) Assignee: Google Inc., Mountain View, CA (US)

(21) Appl. No.: 13/428,760

(22) Filed: Mar. 23, 2012

Related U.S. Application Data
(60) Provisional application No. 61/496,078, filed on Jun. 13, 2011.

(51) Int. Cl. G06K 9/68

(52) U.S. Cl. 382/218

(57) ABSTRACT

Systems, methods and articles of manufacture for establishing true authorship of a master resolution image are described herein. Embodiments of the present invention relate to reducing unauthorized copying of images posted for public display on image transaction sites where posted images for sale by true authors are susceptible to unauthorized copying by other individuals. Further embodiments allow a true author to post a master resolution version of the image in a secured area of the image transaction site that is shielded from public viewing while posting a downgraded version of the image in a public viewing area of the image transaction site. In one embodiment, an unauthorized copy is verified when the unauthorized copy is a copy of the downgraded version of the image in the public viewing area so when compared to the master resolution version, the image can be verified as an unauthorized copy of the downgraded version.

### CROSS-REFERENCE TO RELATED APPLICATIONS

This application is a U.S. nonprovisional patent application which claims the benefit of U.S. Provisional Patent Application No. 61/496,078 filed on Jun. 13, 2011, which is incorporated herein by reference in its entirety.

### BACKGROUND

1. Field of the Invention

This invention related to establishing authorship of posted images on web-based image services.

2. Background Information

Web based image services allow users to search the web for image content. Web based image services also allow authors to post image content available to be viewed on the web. If the image is for sale, posting of the image by a web based image service allows the image to be searched for and viewed on the web by potential buyers of the image. Interested buyers can then purchase the posted image through the web based image service.

In many instances, posted images offered for sale by the web based image service are not protected. Such posted images can be copied by individuals searching the web based image service for image content. The copied images can then be posted elsewhere on the web based image service by the individuals who copied the original image. In such instances, the web based image service cannot distinguish between the image posted by the true author and the copied image. If the copied image is also for sale, the true author does not receive compensation for the copies sold; instead the individual that copied the image and posted the copy receives the compensation. The true author has no way of proving that the copied image is a copy taken from the original image without the true author's permission because the copy of the original image is identical to the original image posted by the true author.

### BRIEF SUMMARY

Embodiments of the invention relate to establishing authorship of posted images on web based image services. In a first embodiment, a computer implemented method for providing an image transaction site having a capability to verify a true authorship of at least one image having a plurality of visual features where each visual feature is acting as a unique identifier of the image. A master resolution image with a plurality of master visual features is received by a secure area of the image transaction site where the master resolution image is not disseminated on a public display of the image transaction site. A downgraded resolution image having a plurality of downgraded visual features is disseminated on the public display of the image transaction site where the downgraded resolution image is a downgraded version of the master resolution image. A plurality of visual features of a third-party image is compared to the plurality of master visual features when the third-party image is disseminated on the public display. An alert is issued when the plurality of visual features of the third-party image is identified as being a copy of the downgraded resolution image.

In a second embodiment, a system provides an image transaction site having a capability to verify true authorship of at least one image having a plurality of visual similarity features where each visual similarity feature acts as a unique identifier of the image. A receiver module receives a master resolution image having a plurality of master visual features to a secure area of the image transaction site where the master resolution image is not disseminated on a public display of the image transaction site. A dissemination module that disseminates on the public display of the image transaction site a downgraded image having a plurality of downgraded visual features where the downgraded resolution image is a downgraded version of the master resolution image. A comparison module compares a plurality of visual similarity features of a third-party image to the plurality of master visual features when the third-party image is disseminated on the public display. An issuance module that issues an alert when the plurality of visual features of the third-party image is identified as being a copy of the downgraded resolution image.

Further embodiments, features, and advantages, as well as the structure and operation of the various embodiments, are described in detail below with reference to the accompanying drawings.

### BRIEF DESCRIPTION OF THE DRAWINGS/FIGURES

Embodiments are described with reference to the accompanying drawings. In the drawings, like reference numbers may indicate identical or functionally similar elements.

FIG. 1 illustrates an image transaction site having a displayed image, according to an embodiment.

FIG. 2A illustrates an image transaction site having a secure area and a public display, according to an embodiment.

FIG. 2B illustrates an image transaction site having a master resolution image stored in a secure area and a downgraded image on public display, according to an embodiment.

FIG. 3 illustrates an image authorship verification computing system architecture, according to an embodiment.

FIG. 4 illustrates a flowchart of an exemplary aspect of operation, according to an embodiment.

### DETAILED DESCRIPTION

In embodiments, an image transaction site provides a capability to establish authorship of displayed images by storing a master resolution image in a secure area while publicly displaying a downgraded version. In the Detailed Description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic may be described in connection with an embodiment, it may submitted that it may be within the knowledge of one skilled in the art to effect such feature, structure, or characteristic in connection with other embodiments whether or not explicitly described.

### Overview

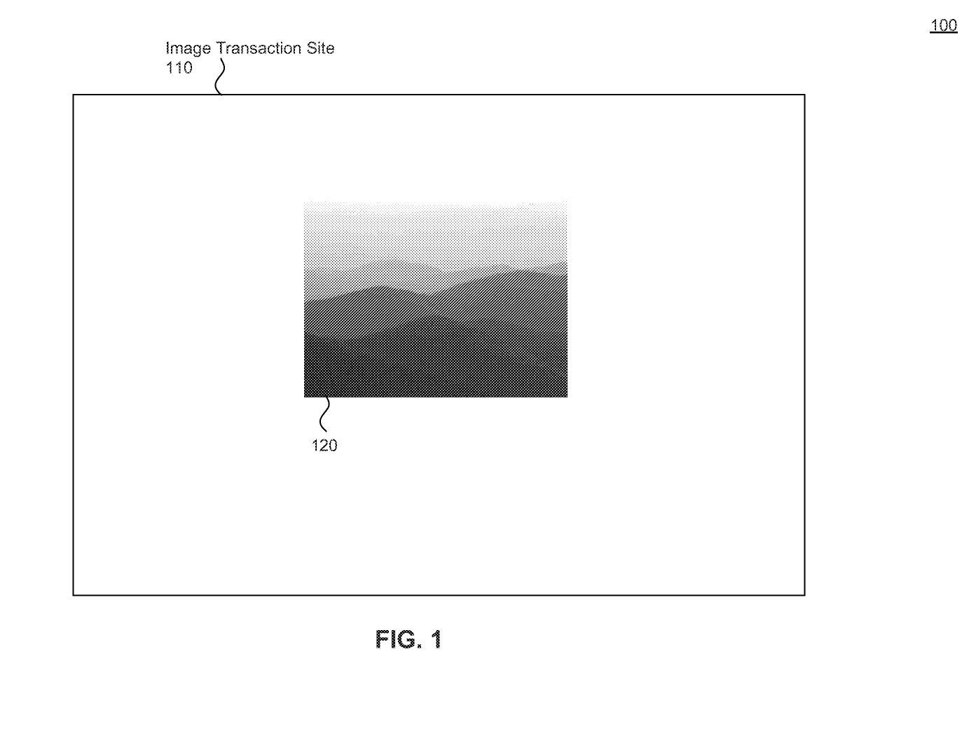

FIG. 1 illustrates an image transaction system 100 according to an embodiment. System 100 includes image transaction site 110. Image transaction site 110 includes displayed image 120.

Generally speaking, embodiments described herein provide image transaction site 110 with a capability to verify true authorship of displayed image 120. Displayed image 120 represents an actual digital image that an author of displayed image 120 would like to display on image transaction site 110. Examples of displayed image 120 include but are not limited to digital representations of a photograph, a drawing, and a painting. Displayed image 120 may be owned by an author. The author may have intentions of publicly displaying and selling displayed image 120. The author may submit displayed image 120 to image transaction site 110 for display and sale.

Image transaction site 110 provides a web based service for displaying images available for purchase. Potential buyers may purchase images displayed on image transaction site 110 such that the true author of the images is compensated.

However, images available for public viewing on image transaction site 110 may be susceptible to copying. For example, if displayed image 120 were posted on image transaction site 110, a third party could search image transaction site 110 and copy displayed image 120 rather than purchasing displayed image 120. A competing copy of displayed image 120 may then be posted on image transaction site 110 for sale so that the true author of displayed image 120 would not be compensated for sales of the copy. Prevention of the sale of the copy requires that image transaction site 110 be able to determine whether the third party image is an original image belonging to the third party or whether it is merely a copy of the true author's original image.

In an embodiment, image transaction site 110 verifies authorship of displayed image 120 by storing a master copy of displayed image 120 on image transaction site 110. Image transaction site 110 may then generate a downgraded copy of displayed image 120 and display the downgraded copy on image transaction site 110 for sale to potential buyers. If an individual happens to copy the downgraded copy, referred to herein as the unauthorized downgraded copy, and post it for sale on image transaction site 110, image transaction site 110 may compare the unauthorized downgraded copy posted for sale to the stored displayed image 120. Image transaction site 110 confirms that the unauthorized downgraded copy has been copied from the downgraded copy generated by image transaction site 110 based on a comparison of the unauthorized downgraded copy to that of the stored displayed image 120. If the unauthorized downgraded copy is of a lower quality than the stored displayed image 120, then image transaction site 110 confirms that the unauthorized downgraded copy has been copied from the downgraded copy displayed on image transaction site 110. Accordingly, the author of the stored displayed image 120 may also be the true author of the downgraded copy.

### Image Transaction Site

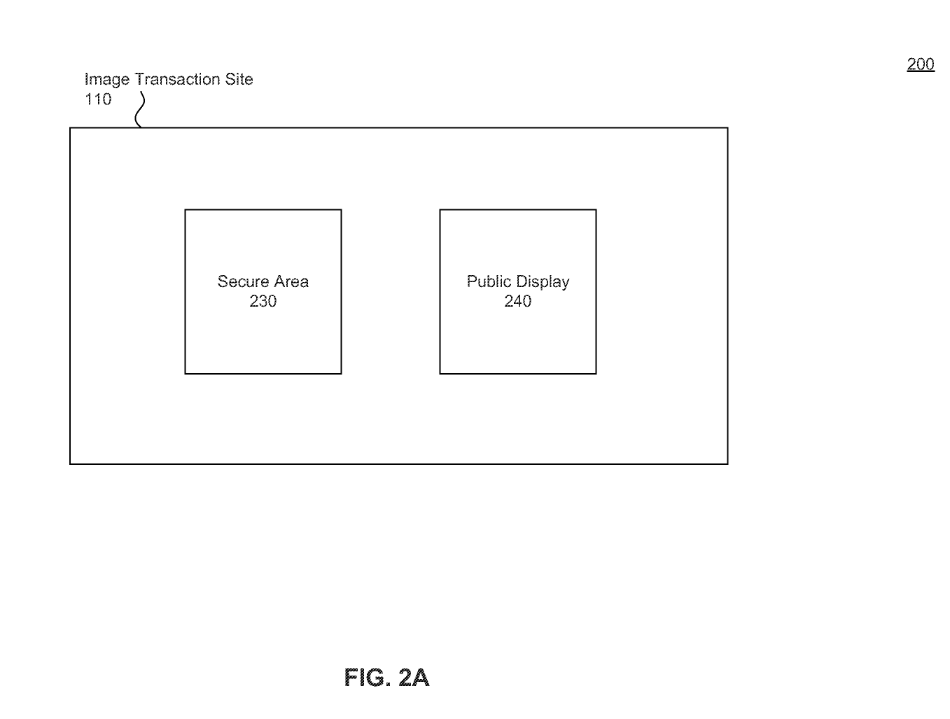

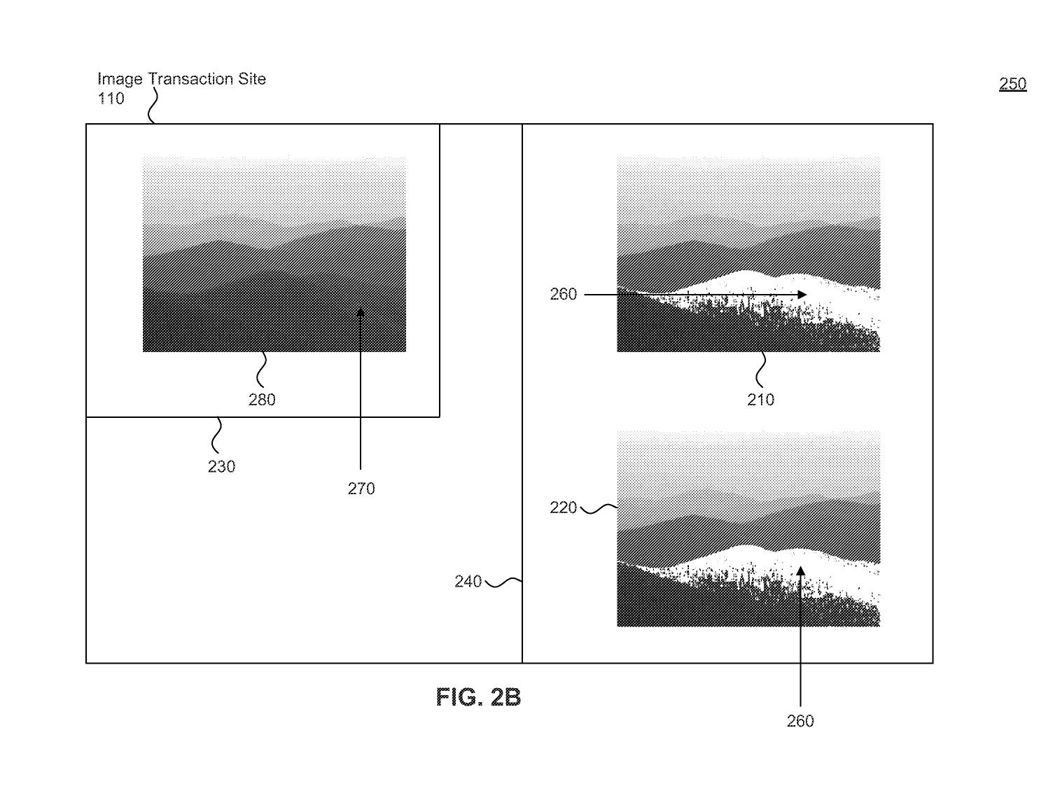

FIG. 2A illustrates one embodiment of an image transaction system 200. Image transaction system 200 includes image transaction site 110, which includes secure area 230 and public display 240.

In an embodiment, image transaction site 110 posts an image for public display on public display 240. Public display 240 may be a portion of image transaction site 110 that displays multiple images to the public. Users of image transaction site 110 may search public display 240 and examine the images displayed on public display 240. Public display 240 may be accessed by web-based search tools used to search for images available for view on the web.

Images stored on image transaction site 110 may be publicly viewed on public display 240. Secure area 230 may not allow public viewing of images stored in secure area 230, and images stored in secure area 230 may not be dispersed to the public.

### Establishing Authorship

FIG. 2B illustrates an embodiment of an image transaction system 250 that stores master resolution image 280 in secure area 230 and displays downgraded resolution image 210 on public display 240. Secure area 230 stores master resolution image 280. Public display 240 displays downgraded resolution image 210 and third-party image 220. Master resolution image 280 has a master visual feature 270. Downgraded resolution image 210 and third-party image 220 each have downgraded visual feature 260.

Master visual feature 270 includes a distinct visual feature unique to master resolution image 280. Downgrading master visual feature 270 generates a second image similar to master resolution image 280 in that the second image exhibits identical content to master resolution image 280. However, the second image and master resolution image 270 differ in that the second image has a visual feature downgraded from master visual feature 270.

Master visual feature 270 may include any type of visual feature included in master resolution image 280 that contributes to the overall visual quality of master resolution image 280. For example, master visual feature 270 may include but is not limited to color, pixel count, resolution, clarity, and polarity. For example, master resolution image 280 may represent a mountain range. As shown in FIG. 2B, master visual feature 270 includes a mountain range exhibited in a black polarity. Any downgrading of the black polarity feature creates the second image that displays the same mountain range as master resolution image 280 but differs in the downgrading of the black polarity feature.

In an embodiment, master resolution image 280 with master visual feature 270 is stored in secure area 230 of image transaction site 110. Secure area 230 of image transaction site 110 protects master resolution image 280 from public viewing and any type of access or unauthorized copying by any party. Master resolution image 280 is not disseminated on public display 240 of image transaction site 110. Master resolution image 280 may be distinguished from other images because only master resolution image 280 includes master visual feature 270.

Downgraded Resolution Image

In an embodiment, downgraded resolution image 210 with downgraded visual feature 260 is disseminated for public viewing on public display 240 of image transaction site 110. Downgraded resolution image 210 may be a downgraded version of master resolution image 280, with visual features having a lower quality than the visual features presented in master resolution image 280.

In such an embodiment, downgraded visual feature 260 may have a lower quality than master visual feature 270. Downgraded visual feature 260 may include any type of visual feature included in downgraded resolution image 210 that contributes to the overall visual quality of downgraded resolution image 210.

For example, master resolution image 280 may be received by image transaction site 110, where master resolution image 280 represents a mountain range. Master visual feature 270 of master resolution image 280 may include, for example without limitation a specific pixel count, resolution, clarity, and a black and white shade of polarity for the mountain range image.

The difference between master resolution image 280 and downgraded resolution image 210 includes the difference between master visual feature 270 and downgraded visual feature 260. Downgraded visual feature 260 has a lower quality because the mountain range is displayed in white polarity rather than the black polarity displayed by master visual feature 270.

In an embodiment, downgraded resolution image 210 may be generated from master resolution image 280. As stated above, master resolution image 280 represents an image with master resolution feature 270. Master resolution feature 270 may be extracted from master resolution image 280 and downgraded to downgraded visual feature 260, generating downgraded resolution image 210. In many cases, the differences between master resolution image 280 and downgraded resolution image 210 are imperceptible to a viewer, but detectable electronically.

In an embodiment, master resolution image 280 is represented by a raw image file that contains data from the image sensor of, for example, a digital camera, image scanner, or motion picture film scanner. The raw image file of master resolution image 280 contains master resolution feature 270. Downgraded resolution image 210 may be generated from the raw image file of master resolution image 280 by, for example, sampling the raw image file at a lower resolution to create downgraded resolution image 210. Sampling the raw image file at a lower resolution generates downgraded visual feature 260 from master resolution feature 270, creating downgraded resolution image 210.

In another embodiment, the raw image file of master resolution image 280 may be downgraded by generating a JPEG representation of the raw image file of master resolution image 280. The JPEG representation of the raw image file of master resolution image 280 contains downgraded features, such as downgraded visual feature 260, of master resolution image 280. In such an embodiment, downgraded resolution image 210 is the JPEG representation of the raw image file of master resolution image 280.

Comparing Images

In an embodiment, master resolution image 280 is stored in secure area 230 of image transaction site 110, while downgraded resolution image 210 is publicly disseminated on public display 240 of image transaction site 110. As noted above, master resolution image 280 may be stored in secure area 230 of image transaction site 110 so that master resolution image 280 is protected from public view and potential copying. However, the true author of master resolution image 280 may wish to display master resolution image 280 on image transaction site 110 so that potential buyers may view and purchase master resolution image 280 from the true author. According to an embodiment, rather than publicly displaying master resolution image 280, downgraded resolution image 210 is publicly displayed on public display 240 of image transaction site 110.

Although downgraded resolution image 210 is a lower resolution version of master resolution image 280, downgraded resolution image 280 is still of sufficient quality to be useful to a purchaser. For example, master resolution image 280 may have a resolution of five megapixels, while downgraded resolution image 210 may have a resolution of four megapixels. If an unauthorized copy of the image were to occur, the unauthorized copy would be of downgraded resolution image 210 and not master resolution image 280.

Publicly displaying downgraded resolution image 210 on public display 240 of image transaction site 110 makes downgraded resolution image 210 susceptible to being copied by a third-party without authorization from the true author. The third-party may copy downgraded resolution image 210, generating third-party image 220. Third-party image 220 may be an identical copy of downgraded resolution image 210. The third-party may then post third-party image 220 on public display 240 of image transaction site 110 so that third-party image 220 is viewed by potential buyers.

The posting of third-party image 220 on public display 240 of image transaction site 110 may result in an authorship dispute between the true author of master resolution image 280 and the third party. In order to establish authorship of third-party image 220 and confirm that third-party image 220 is a copy and not an original image, third-party image 220 may be compared to master resolution image 280. As noted above, master resolution image 280 with master visual feature 270 may be stored in secure area 230 of image transaction site 110. Third-party image 220 may then be compared to master resolution image 280. Since master resolution image 280 with master visual feature 270 is not available to the public, third-party image 220 may not have master visual feature 270 but may instead have downgraded visual feature 260.

A comparison of master resolution image 280 having master visual feature 270 to third-party image 220 having downgraded visual feature 260 confirms that third-party image 220 is a copy of downgraded resolution image 210. The third-party that copied and posted third-party image 220 is not the true author of third-party image 220 but rather the author of master resolution image 280 is the true author of third-party image 220. In comparing third-party image 220 to master resolution image 280, the only difference in the image may be, for example, downgraded visual feature 260 of third-party image 220 as compared to master visual feature 270 of master resolution image 280. Such a difference confirms that a third-party copied third-party image 220 from downgraded resolution image 210 and is not the true author of third-party image 220.

If the visual features of third-party image 220 match master visual features 270 of master resolution image 280, then image transaction site 110 may not be able to confirm whether third-party image 220 is a copy. Such a third-party image 220 may be a second copy of master resolution image 280 disseminated by the true author somewhere other than secure area 230 of image transaction site 110. Alternatively, third-party image 220 may be an image taken by a second author where the second author happened to take the same image as the true author of master resolution image 280. Regardless of the origin, third-party image 220 with master visual feature 270 cannot be confirmed as an unauthorized copy of master resolution image 280.

In an embodiment, a comparison of master visual features 270 of master resolution image 280 with downgraded visual features 260 of third-party image 220 may be performed to confirm that third-party image 220 is a copy of downgraded resolution image 210. This comparison may entail extracting master visual features 270 from master resolution image 280 and comparing those features to downgraded visual features 260 from third-party image 220. If the extractions do not match, then third-party image 220 may be a copy of downgraded resolution image 210 and not an original image. Extracting and comparing of visual features from images may include, but are not limited to, using a browser plug-in or a visual algorithm.

In an embodiment, an alert may be issued when third-party image 220 is confirmed to be a copy of downgraded resolution image 210 when compared to master resolution image 280. The true author of master resolution image 280 may not desire to have an unauthorized copy of downgraded resolution image 210 displayed on public display 240 of image transaction site 110. An alert may be issued making known that third-party image 220 is displayed on public display 240 and that third-party image 220 may be an unauthorized copy of downgraded resolution image 210. In an embodiment, third-party image 220 may be blocked from being disseminated on public display 240 of image transaction site 110 when the alert is issued.

### System 300

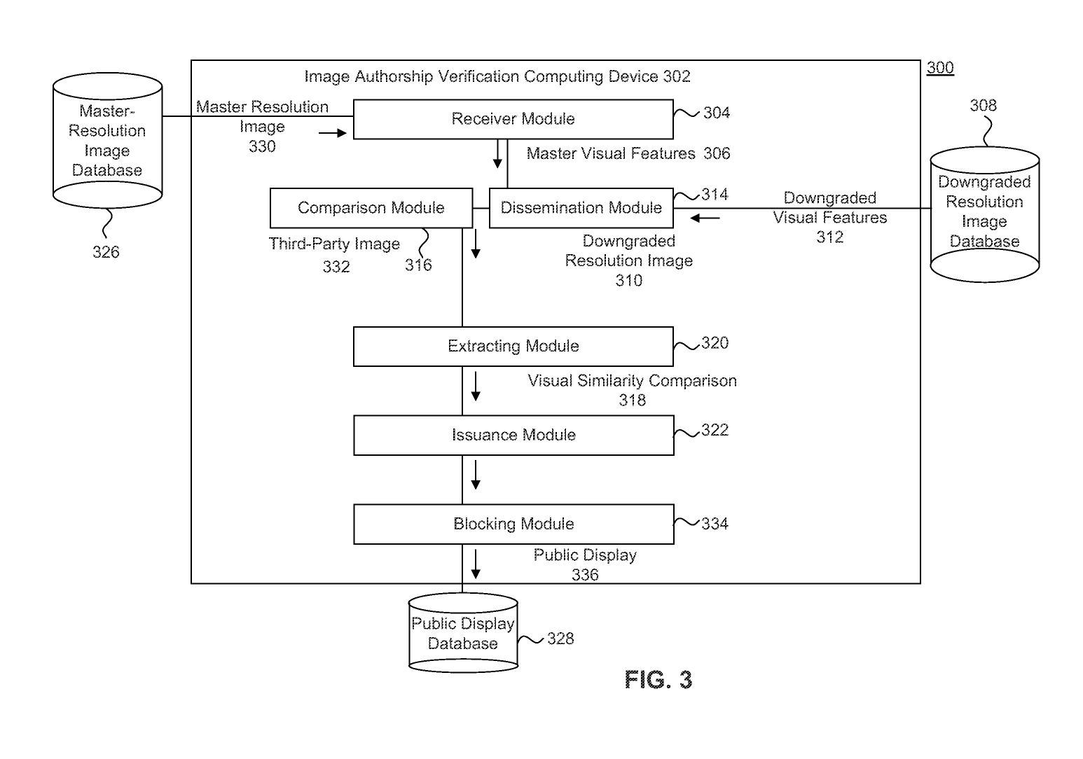

FIG. 3 is an example database system architecture 300 in which embodiments of the present invention, or portions thereof, may be implemented. System architecture 300 includes image authorship verification computing device 302 coupled to master resolution image database 326. Image authorship verification computing device 302 may also be coupled to downgraded resolution image database 308 and public display database 328. While the embodiment depicted in FIG. 3 shows image authorship verification computing device 302 connected to master resolution image database 326, downgraded resolution image database 308, and public display database 328, it is important to note that embodiments can be used to exchange data between a variety of different types of computer-implemented data sources, systems and architectures. For example, architecture 300 may be distributed over a networked cloud.

Image authorship verification computing device 302 has receiver module 304 that receives master resolution image 330. Dissemination module 314 receives master visual features 306 and downgraded visual features 312. Dissemination module 314 disseminates downgraded resolution image 310. Comparison module 316 compares image features of third-party image 332 to master visual features 306. Extracting module 320 extracts the image features of third-party image 332 and master visual features 306 and generates a visual similarity comparison 318. Issuance module 322 issues an alert when third-party image 332 is a copy of downgraded resolution image 310. Blocking module 334 blocks third-party image 332 from being displayed on public display 336.

In general, image authorship verification computing device 302 operates as follows. Master resolution image database 326 supplies a master resolution image 330, where master resolution image 330 includes master visual features 306. Receiver module 304 receives master resolution image 330.

Dissemination module 314 receives downgraded visual features 312 from downgraded resolution image database 308 and master visual features 306 from receiver module 304. Dissemination module 314 disseminates downgraded resolution image 310 on public display 336. Downgraded resolution image 310 includes downgraded visual features 312. Downgraded resolution image 310 may differ from master resolution image 330 because master visual features 306 differ from downgraded visual features 312.

Comparison module 316 compares third-party image 332 to master resolution image 330. In an embodiment, master resolution image 330 includes master visual features 306. Third-party image 332 may be an unauthorized copy of downgraded resolution image 310 that is displayed on public display 336. Third-party image 332 may include downgraded visual features 312, since third-party image 332 may be an unauthorized copy of downgraded resolution image 310. Comparison module 316 compares third-party image 332 to master resolution image 330 to determine whether visual features of third-party image 332 match master visual features 306 of master resolution image 330.

In an embodiment, extracting module 320 executes a visual similarity comparison 318 to determine whether visual features of third-party image 332 match master visual features 306 of master resolution image 330. Extracting module 320 extracts visual features from third-party image 332 and also extracts master visual features 306 from master resolution image 330. If visual features from third-party image 332 are similar to master visual features 306 of master resolution image 330 but of lower quality, third-party image 332 is identified as an unauthorized copy of downgraded resolution image 310.

Issuance module 322 issues an alert when third-party image 332 is identified as downgraded resolution image 310. Upon receiving the alert from issuance module 322, blocking module 334 blocks third-party image 332 from public display 336.

Modules as described above may be used by image authorship verification computing device 302. As referred to herein, a module may be any type of processing (or computing) device having one or more processors. For example, a module can be an individual processor, workstation, mobile device, computer, cluster of computers, set-top box, game console or other device having at least one processor. In an embodiment, multiple modules may be implemented on the same processing device. Such a processing device may include software, firmware, hardware, or a combination thereof. Software may include one or more applications and an operating system. Hardware can include, but may not be limited to, a processor, memory, and/or graphical user display.

### Method 400

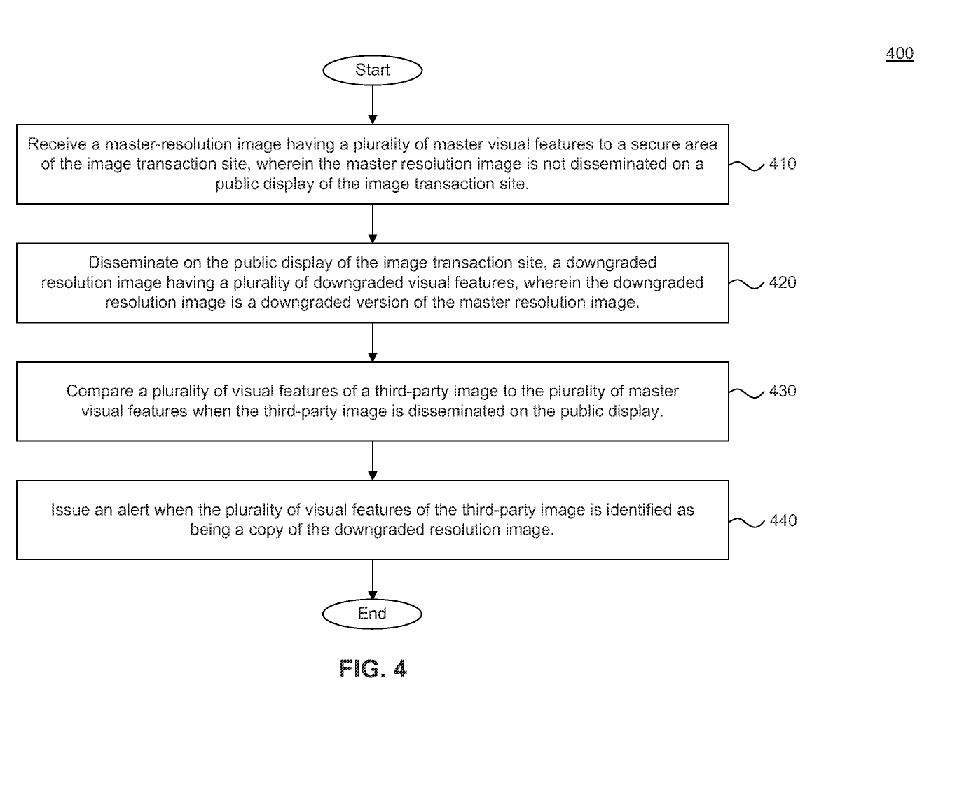

FIG. 4 illustrates an exemplary method 400 for verifying authorship of an image, according to an embodiment. As shown in FIG. 4, method 400 begins at step 410, where a master resolution image having a plurality of master visual features is received by a secure area of an image transaction site. For example, as shown in FIG. 2B, the master resolution image, such as master resolution image 280, having master visual feature 270, is received into secure area 230 of image transaction site 110. The master resolution image, such as master resolution image 280, is not disseminated on a public display, such as public display 240, of the image transaction site. Step 410 may be performed by, for example, receiver module 304. Once step 410 is complete, method 400 proceeds to step 420.

At step 420, a downgraded resolution image is generated and disseminated on the public display of the image transaction site. For example, as shown in FIG. 2B, a downgraded resolution image, such as downgraded resolution image 210 having downgraded visual feature 260, is disseminated on public display 240 of image transaction site 110. Downgraded resolution image 210 is a downgraded version of master resolution image 280. Step 420 may be performed by, for example dissemination module 310. Once step 420 is complete, method 400 proceeds to step 430.

At step 430, a visual feature of a third-party image is compared to the master visual feature when the third-party image is disseminated on the public display. This step may be initiated automatically by the image transaction site, or it may be initiated upon request of the true author of the master resolution image or any other viewer who notices a similarity between the master resolution image and the third party image. For example, as shown in FIG. 2B, downgraded visual feature 260 of third-party image 220 is compared to master visual feature 270 when third-party image 220 is disseminated on public display 240. Step 430 may be performed by, for example extracting module 320. Once step 430 is complete, method 400 proceeds to step 440.

At step 440, an alert is issued when the third-party image is identified as being downgraded compared to the master resolution image. For example, as shown in FIG. 2B, an alert is issued when downgraded visual feature 260 of third-party image 220 is identified as being downgraded compared to master visual feature 270, implying that third-party image 220 is a copy of the downgraded version of master resolution image 280. Step 440 may be performed by, for example issuance module 332. When step 440 is completed, method 400 ends.

Embodiments can work with software, hardware, and/or operating system implementations other than those described herein. Any software, hardware, and operating system implementations suitable for performing the functions described herein can be used. Embodiments are applicable to both a client and to a server or a combination of both.

The Brief Summary and Abstract sections may set forth one or more but not all exemplary embodiments as contemplated by the inventors, and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computer implemented method for providing an image transaction site to verify a true authorship of at least one image having a plurality of visual features, each visual feature acting as a unique identifier of the image, comprising:
receiving a master resolution image having a plurality of master visual features at a secure area of the image transaction site, wherein the master resolution image is not disseminated on a public display of the image transaction site;
disseminating, on the public display of the image transaction site, a downgraded resolution image having a plurality of downgraded visual features, wherein the downgraded resolution image is a downgraded version of the master resolution image;
comparing a plurality of visual features of a third-party image to the plurality of master visual features when the third-party image is disseminated on the public display; and
issuing an alert when the plurality of visual features of the third-party image is identified as being a copy of the downgraded resolution image.

2. The method of claim 1, further comprising:
blocking the third-party image from being disseminated on the public display of the image transaction site when the alert is issued.

3. The method of claim 1, further comprising:
extracting the plurality of master visual features from the master resolution image to enable a visual comparison to the third-party image.

4. The method of claim 3, wherein the extracting is performed by a browser plug-in.

5. The method of claim 1, wherein the comparing comprises comparing the plurality of visual features of the third-party image to the plurality of master visual features of the master resolution image according to a visual algorithm.

6. The method of claim 1, wherein the downgraded resolution image is created by downgrading the plurality of master visual features of the master resolution image generating the plurality of downgraded visual features.

7. The method of claim 6, wherein the master resolution image is represented by a raw image file, and wherein the plurality of the master visual features for the raw image file is downgraded to create the downgraded resolution image.

8. The method of claim 7, wherein the downgraded resolution image is a JPEG image.

9. A system for providing an image transaction site to verify a true authorship of at least one image having a plurality of visual similarity features, each visual similarity feature acting as a unique identifier of the image, comprising:
a receiver module that receives a master resolution image having a plurality of master visual features to a secure area of the image transaction site, wherein the master resolution image is not disseminated on a public display of the image transaction site;
a dissemination module that disseminates, on the public display of the image transaction site, a downgraded resolution image having a plurality of downgraded visual features, wherein the downgraded resolution image is a downgraded version of the master resolution image;
a comparison module that compares a plurality of visual similarity features of a third-party image to the plurality of master visual features when the third-party image is disseminated on the public display; and
an issuance module that issues an alert when the plurality of visual features of the third-party image is identified as being a copy of the downgraded resolution image.

10. The method of claim 9, further comprising:
a blocking module that blocks the third-party image from being disseminated on the public display of the image transaction site when the alert is issued.

11. The method of claim 9, further comprising:
an extraction module that extracts the plurality of master visual features from the master resolution image to enable a visual similarity comparison to the third-party image.

12. The method of claim 11, wherein the extracting is performed by a browser plug-in.

13. The method of claim 9, wherein the comparing comprises comparing the plurality of downgraded visual features of the third-party image to the plurality of master visual features of the master resolution image according to a visual algorithm.

14. The method of claim 9, wherein the downgraded resolution image is created by downgrading the plurality of master visual features of the master resolution image generating the plurality of downgraded visual features.

15. The method of claim 14, wherein the master resolution image is represented by a raw image file, and wherein the plurality of the master visual features for the raw image file is downgraded to create the downgraded resolution image.

16. The method of claim 15, wherein the downgraded resolution image is a JPEG image.
